(19) United States
(12) Patent Application Publication
(10) Pub. No.: US 2021/0306883 A1
(43) Pub. Date: Sep. 30, 2021

(54) Accessing VoIP Call Quality

(71) Applicant: Spectralink Corporation, Boulder, CO (US)

(72) Inventors: Elliott Ellison, Boulder, CO (US); Gaurav Batra, Boulder, CO (US); Andrew Gouin, Boulder, CO (US); Vivek Madhavan, Boulder, CO (US); Frank Carpenter, Boulder, CO (US); Christophe Durand, Boulder, CO (US)

(73) Assignee: Spectralink Corporation, Boulder, CO (US)

(21) Appl. No.: 17/210,075

(22) Filed: Mar. 23, 2021

Related U.S. Application Data
(60) Provisional application No. 62/994,611, filed on Mar. 25, 2020.

(51) Int. Cl. H04W 24/08; H04M 7/00

(52) U.S. Cl. CPC H04W 24/08; H04W 84/12; H04M 7/006

(57) ABSTRACT

A computer implemented method includes obtaining voice over Internet Protocol (VoIP) communication quality data for a communication associated with a user device communicating via an access point. The communication is associated with quality data. For each communication, the quality data is segmented into a plurality of segments each corresponding to a respective segment of the communication. For each segment, the method includes determining a score for the segment indicative of an evaluation of an overall quality of the segment, and associating the score with the user device and the access point. The method also includes determining a performance for the user device user device and for the access point based on the scores associated with the user device and the access point.

### CROSS REFERENCE TO RELATED APPLICATIONS

This application claims priority under 35 U.S.C. § 119(e) to U.S. Provisional Application 62/994,611, filed on Mar. 25, 2020. The disclosure of this prior application is considered part of the disclosure of this application and is hereby incorporated by reference in its entirety.

### TECHNICAL FIELD

This disclosure relates to accessing voice over Internet Protocol (VoIP) call quality.

### BACKGROUND

The prevalence of high bandwidth digital wireless networks have helped to greatly increased the use of voice communications and multimedia sessions over Internet Protocol networks (i.e., the Internet). For example, voice over Internet Protocol (VoIP) is a common method for delivering voice and/or other multimedia over the Internet. However, VoIP call quality is known to be susceptible to network issues (e.g., jitter). The ITU (International Telecommunications Union) has created a standard for measuring VoIP call quality. This standard is generally referred to as the mean opinion score (MOS). Wi-Fi is a common wireless network often used when communicating via VoIP. However, Wi-Fi connections are far less stable than wired network connections and as such VoIP calls made over Wi-Fi (i.e., VoWi-Fi) are more difficult to achieve consistently good call quality.

### SUMMARY

One aspect of the disclosure provides computer implemented method that, when executed by data processing hardware, causes the data processing hardware to perform operations. The operations include obtaining voice over Internet Protocol (VoIP) communication quality data for at least one VoIP communication, each VoIP communication associated with a respective user device of a plurality of user devices communicating via at least one respective access point of a plurality of access points, and each VoIP communication associated with respective VoIP communication quality data. The operations also include, for each VoIP communication, segmenting the VoIP communication quality data into a plurality of data quality segments, each data quality segment corresponding to a respective segment of the VoIP communication. The operations also include, for each data quality segment, determining a segment mean opinion score for the data quality segment indicative of an evaluation of an overall quality of the data quality segment, and associating the segment mean opinion score with the respective user device and each respective access point. The operations also include, determining an independent historical quality performance for the user device of the plurality of user devices and for the at least one access point of the plurality of access points based on the segment mean opinion scores associated with the user device and the at least one access point.

Implementations of the disclosure may include one or more of the following optional features. In some implementations, the operations further include determining an independent historical quality performance for each user device of the plurality of user device and for each access point of the plurality of access points based on the segment mean opinion scores associated with each respective user device and each access point. Optionally, the VoIP communication quality data includes at least one of jitter, latency, or packet loss.

In some examples, the VoIP communication quality data includes voice over Wi-Fi communication quality data. In some configurations, at least one of the VoIP communications is associated with a respective user device of the plurality of user devices communicating via at least two respective access points of the plurality of access points.

In some implementations, obtaining the VoIP communication quality data includes obtaining the VoIP communication quality data in real-time, and the operations further include determining a communication quality score for the VoIP communication associated with the real-time VoIP communication quality data based on the segment mean opinion scores, determining a different access point within range of the user device when the communication quality score satisfies a threshold, and switching the VoIP communication to the different access point.

In some examples, the operations further include, for each VoIP communication, determining a communication mean opinion score for each access point associated with the respective VoIP communication. In some implementations, determining the independent historical quality performance of the at least one access point of the plurality of access points includes determining a weighted average of the segment mean opinion scores associated with the at least one access point.

In some configurations, determining the independent historical quality performance of the user device of the plurality of user devices includes determining a weighted average of the segment mean opinion scores associated with the user device. Optionally, the weighted average of the segment mean opinion scores associated with each user device is weighted based on a call duration of the corresponding VoIP communication associated with each segment mean opinion score.

Another aspect of the disclosure provides a system including data processing hardware and memory hardware in communication with the data processing hardware. The memory hardware stores instructions that, when executed on the data processing hardware, cause the data processing hardware to perform operations. The operations include receiving voice over Internet Protocol (VoIP) communication quality data for a plurality of VoIP communications, each VoIP communication associated with a respective user device of a plurality of user devices communicating via at least one respective access point of a plurality of access points, and each VoIP communication associated with respective VoIP communication quality data. The operations also include, for each VoIP communication, splitting the VoIP communication quality data into a plurality of data quality segments, each data quality segment corresponding to a respective segment of the VoIP communication. The operations also include, for each data quality segment, determining a segment mean opinion score for the data quality segment indicative of an evaluation of an overall quality of the data quality segment, and associating the segment mean opinion score with the respective user device and each respective access point. Another operation includes determining an independent historical quality performance for the user device of the plurality of user devices and for the at least one access point of the plurality of access points based on the segment mean opinion scores associated with the respective user device and the at least one access point. This aspect of the disclosure may include one or more of the following optional features.

In some implementations, the operations further include determining an independent historical quality performance for each user device of the plurality of user device and for each access point of the plurality of access points based on the segment mean opinion scores associated with each respective user device and each access point. Optionally, the VoIP communication quality data includes at least one of jitter, latency, or packet loss.

In some configurations, the VoIP communication quality data includes voice over Wi-Fi communication quality data. In some examples, at least one of the VoIP communications is associated with a respective user device of the plurality of user devices communicating via at least two respective access points of the plurality of access points.

In some implementations, obtaining the VoIP communication quality data includes obtaining the VoIP communication quality data in real-time and the operations further include determining a communication quality score for the VoIP communication associated with the real-time VoIP communication quality data based on the segment mean opinion scores, determining a different access point within range of the user device when the communication quality score satisfies a threshold, and switching the VoIP communication to the different access point.

In some implementations, the operations further includes, for each VoIP communication, determining a communication mean opinion score for each access point associated with the respective VoIP communication. In some examples, determining the independent historical quality performance of the at least one access point of the plurality of access points includes determining a weighted average of the segment mean opinion scores associated with the at least one access point.

In some configurations, determining the independent historical quality performance of the user device of the plurality of user devices includes determining a weighted average of the segment mean opinion scores associated with the user device. Optionally, the weighted average of the segment mean opinion scores associated with each user device is weighted based on a call duration of the corresponding VoIP communication associated with each segment mean opinion score.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a system for determining a quality of a voice over Internet Protocol (VoIP) communication.

FIG. 2 is a schematic view of segmentation of a VoIP communication.

FIG. 3 is a schematic view of a user device and two access points and associated data quality segments.

FIG. 4 is a schematic view of an exemplary application displaying user device statistics.

FIGS. 5A-5D are schematic views of the exemplary application of FIG. 4 displaying performance data associated with a plurality of user devices and a plurality of access points.

FIGS. 6A-6C are schematic views of the exemplary application of FIG. 4 displaying and plotting mean opinion scores of a plurality of segments of a VoIP communication.

FIG. 7 is a flowchart of an example arrangement of operations for a method of determining a quality of VoIP communication.

FIG. 8 is a schematic view of an example computing device that may be used to implement the systems and methods described herein.

Like reference symbols in the various drawings indicate like elements.

### DETAILED DESCRIPTION

As technologies such as voice over Internet Protocol (VoIP) continue to rise in prevalence, the importance of VoIP communication quality also increases in importance. However, VoIP is known to fail (e.g., have noticeable communication degradation) when network issues (e.g., jitter) are present. VoIP is often conducted over Wi-Fi, but Wi-Fi connections are typically less stable than wired network connections and thus VoIP communications made over Wi-Fi (i.e., VoWi-Fi) are more difficult to achieve consistently good communication quality.

The ITU (International Telecommunications Union) has created a standard for measuring VoIP communication quality. This standard is generally referred to as the mean opinion score (MOS). This MOS equation uses inputs, such as jitter, latency and packet loss, during a VoIP communication to calculate a score of between 0 and 5 to assess the average communication quality experienced the user. By some standards, a communication that is determined to have an MOS of greater than 4.0 is considered a good quality communication. However, MOS is not a perfect measure of communication quality. In averaging out communication quality issues (i.e., determining the mean), a communication with a brief poor communication quality experience may still have a score above 4.0 and be classified as a good communication despite the participants experiencing substantial communication degradation. This result is, in part, due to sampling time as when quality is sampled on the entirety of the communication, the sample may not reflect the true communication quality. This issue may be exacerbated for longer communications.

Typical methods for determining VoIP communication quality (e.g., the ITU MOS method) assume a consistent wired network connection. However, when a user device uses VoIP over a wireless network such as Wi-Fi, the user device may roam between different access points and the quality of the network connection between the user device and the access point is continually changing. This is a dramatically different situation than a wired connection. Previous attempts at determining VoIP communications do not consider, for example, roaming between Wi-Fi access points. However, each access point provides a unique network experience which can dramatically affect call quality.

Implementations herein are directed toward a VoIP quality determiner that determines an independent historical quality performance for a user device of a fleet of user devices and at least one access point used by the user devices to communicative via VoIP. The VoIP quality determiner includes a data segmenter that segments the VoIP communication into a plurality of segments, each with a corresponding data quality segment. Each data quality segment is associated with a specific user device and access point. Each data quality segment associated with a specific user device or access point determines the independent historical quality performance for that user device or access point.

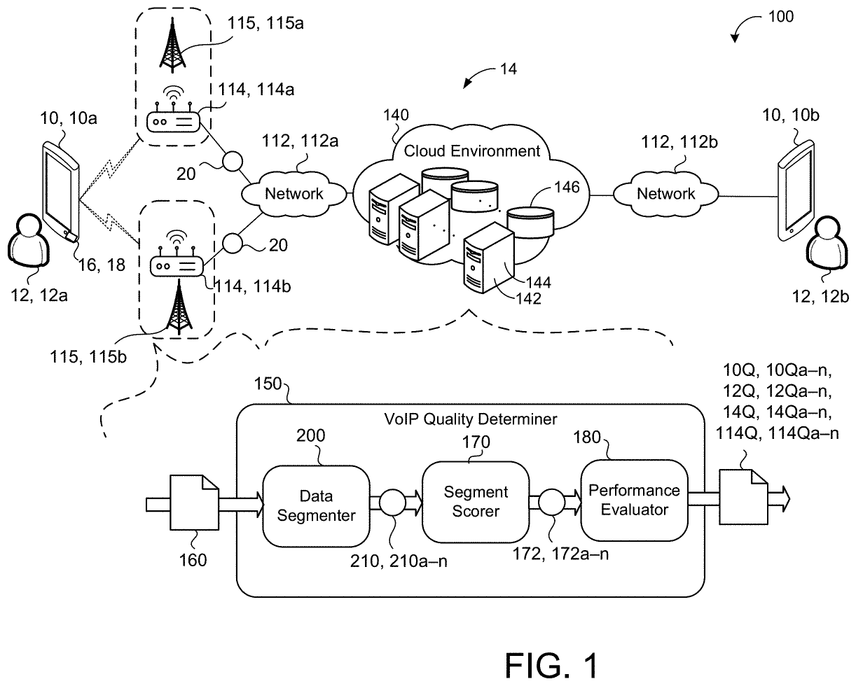

Referring to FIG. 1, in some implementations, an example system 100 includes two or more user devices 10, 10a-n, each associated with a respective user 12, 12a-n and each in communication with a remote system 140 via a network 112, 112a-n. The user devices 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware).

The remote system 140 may be a single computer, multiple computers, or a distributed system (e.g., a cloud environment) having scalable/elastic computing resources 144 (e.g., data processing hardware) and/or storage resources 142 (e.g., memory hardware). A data store 146 (i.e., a remote storage device 146) may be overlain on the storage resources 142 to allow scalable use of the storage resources 142 by one or more of the client or computing resources 144. The remote system 140 is configured to receive VoIP communication quality data 160 associated with a video and/or voice data signal, such as a Voice over Internet Protocol (VoIP) call, between user devices 10, 10a-b through the networks 112, 112a-b. In some implementations, each user device 10 communicates wirelessly with a wireless access point (AP) 114, 114a-n, which in turn communicates with the respective network 112. Each wireless access point 114 represents networking hardware that allows wireless devices (e.g., Wi-Fi devices) to connect to a wired network. The AP 114 may connect to or be integrated with a router. In other implementations, one or both user devices 10 communicates with a cellular network tower 115, 115a-n, which in turn communicates with the respective network 112. For example, one or both user devices 10 may communicate using typical cellular networks (2G, 3G, 4G, 5G, etc.). Herein, references to access points 114 may also refer to cellular network towers 115.

Therefore, a first caller 12a using a first user device 10a may initiate a voice and/or video communication to a second user device 10b through remote system 140. The user devices 10, 10a-b communicate by sending a digital communication data signal through the network 112, 112a-b. In some example, the data signals pass through the remote system 140, while in other examples, the remote system 140 receives the VoIP communication quality data 160 while the actual call data 20 is routed through different remote systems. The communication data signal is split into a series packets 20, via, for example, the TCP/IP or UDP protocol, with each packet 20 including one or more audio/video samples 22 of the communication signal from the respective user device 10, 10a-b.

The remote system 140 or the user device 10a executes a VoIP quality determiner 150 to determine a quality of a VoIP communication 14 between the first user device 10a and the second user device 10b. The VoIP quality determiner 150 includes a data segmenter 200 that receives the VoIP communication quality data 160 associated with the VoIP communication 14 between the first user device 10a and the second user device 10b. The VoIP communication quality data 160 may include any data pertaining to a measure of quality of the corresponding VoIP communication 14. For example, the VoIP communication quality data 160 may include jitter information, latency information, packet loss information (i.e., a number and/or frequency of packets 20 lost), and/or codec information (i.e., information regarding the codec used by the user device 10). In some examples, the VoIP communication quality data 160 only includes jitter information and packet loss. In some examples, the VoIP communication includes a voice over Wi-Fi communication and correspondingly the VoIP communication quality data 160 may include voice over Wi-Fi communication quality data.

While examples herein refer to a VoIP communication 14, it is understood that many different types of communications are applicable. For example, one user device 10 may connect to the other user device via a wireless or wired connection to the Internet (e.g., via Wi-Fi or Bluetooth), via a public switched telephone network (PSTN), via a cellular network, or any combination thereof. Each user device 10 may connect using the same method or each user device 10 may connect using a different method. The VoIP quality determiner 150 may receive VoIP communication quality data 160 from one device 10 participating in the communication 14 or from both devices 10. In some implementations, the communication 14 may include three or more user devices 10 participating in the communication 14 and the VoIP quality determiner 150 receives VoIP communication quality data 160 from at least a portion of the user devices 10.

The data segmenter 200 segments the VoIP communication quality data 160 into a plurality of data quality segments 210, 210a-n. In some examples, the data segmenter 200 receives VoIP communication quality data 160 that is representative of the entire communication 14 between the first user device 10a and the second user device 10b. In other examples, the data segmenter 200 receives the VoIP communication quality data 160 in approximately real-time (i.e., as the communication between the devices 10a, 10b, occurs) and segments the data 160 as it arrives.

The data segmenter 200 passes each data quality segment 210 to a segment scorer 170. Each data quality segment 210 is associated with a respective user device 10 and access point 114. That is, each data quality segment 210 is associated with the user device(s) 10 that is associated with the corresponding VoIP communication 14 and the access point(s) 114 that the user device 10 used to conduct the corresponding VoIP communication 14. In some examples, the VoIP quality determiner 150 determines the quality for only the first user device 10a and therefore not associate the second user device 10b with any data quality segments 210. In other examples, the VoIP quality determiner 150 determines a quality of the VoIP communication for both the first user device 10a and the second user device 10b and thus both user devices 10a, 10b are associated with the respective data quality segments 210.

The segment scorer 170 receives each data quality segment 210 and assigns an individual segment mean opinion score 172, 172a-n to the respective segment 210. The segment mean opinion score 172 is an evaluation of an overall quality of the data quality segment 210. For example, the score is based in part on the jitter, the latency, and/or the packet loss of the corresponding segment of the VoIP communication 14. Each segment mean opinion score 172 may include indications of associated user devices 10 and access points 114. For example, when the first user device 10a is connected to the network 112a via the access point 114a and the second user device 10b is connected to the network 112b via access point 114c (not shown), each corresponding data quality segment 210 of the resulting VoIP communication includes a segment mean opinion score 172 that is associated with the user device 10a, the user device 10b, the access point 114a, and the access point 114c. In some examples, the segment scorer 170 discards the data quality segments 210 after determining the respective segment mean opinion score 172 of the data quality segment 210.

Each segment mean opinion score 172 is passed to a performance evaluator 180. The performance evaluator 180 determines an independent historical quality performance 10Q, 10Qa-n, 114Q, 114Qa-n for the first user device 10a and each access point 114 the first user device 10a used to conduct the VoIP communication 14. That is, using each segment mean opinion score 172 associated with the first user device 10a, the performance evaluator 180 determines the historical quality performance 10Qa for the first user device 10a. Similarly, using each segment mean opinion score 172 associated with the at least one access point 114 that the first user device 10a used to conduct the VoIP communication 14, the performance evaluator 180 determines the historical quality performance 114Qa for the at least one access point 114a.

In some implementations, the performance evaluator 180 determines a historical quality performance 10Q, 114Q for both the first user device 10a and the second user device 10b and for each access point 114 used to conduct the VoIP communication 14. Optionally, the performance evaluator 180 determines and maintains independent historical quality performances 10Q, 114Q for each user device 10 of a fleet of user devices 10 and the corresponding access points 114 used to connect each of the user devices 10 to the networks 112. That is, the performance evaluator 180 may maintain a historical quality performance 10Q, 114Q for each user device 10 of the fleet and each access point 114 that the user devices 10 use to connect for VoIP communications 14. The performance evaluator 180 may update the historical quality performance 10Q, 114Q for a corresponding user device 10 or access point 114 each time the performance evaluator 180 receives additional segment mean opinion scores 172 associated with the respective user device 10 or access point 114. For example, after the performance evaluator 180 has already determined a historical quality performance 10Qa for the user device 10a, the user device 10a conducts an additional VoIP communication 14 that subsequently generates VoIP communication quality data 160. Using the new VoIP communication quality data 160, the performance evaluator 180 may update the historical quality performance 10Qa for the user device 10a based on the new VoIP communication quality data 160.

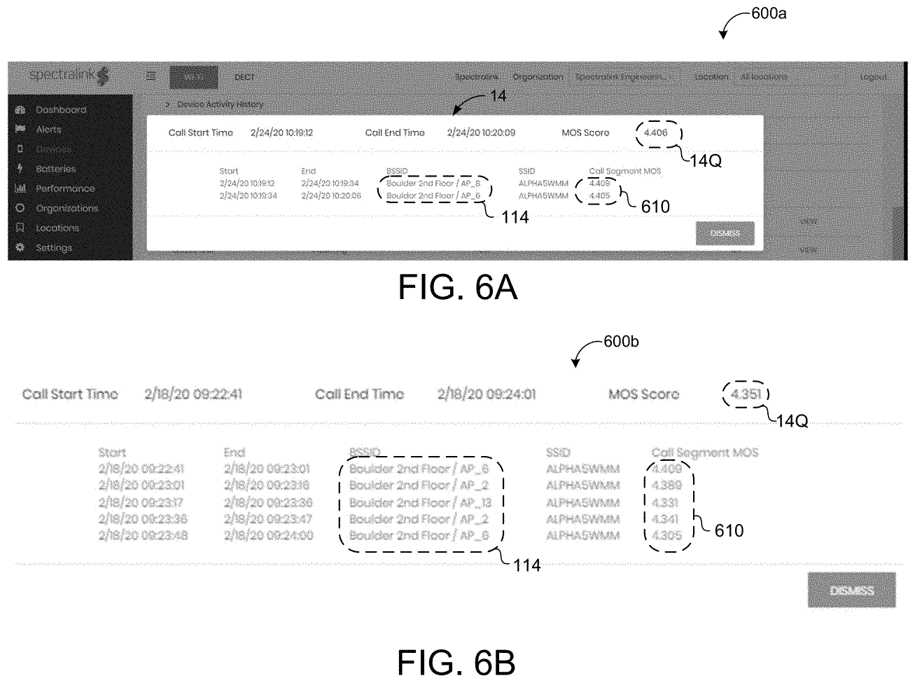

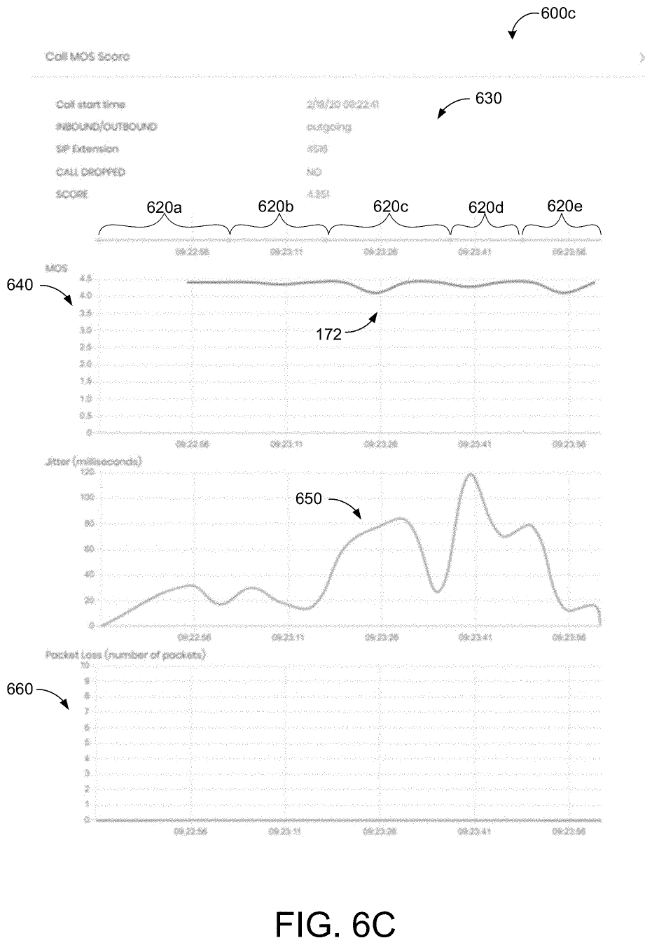

In some examples, the performance evaluator 180, for each VoIP communication 14, determines a communication mean opinion score 14Q, 14Qa-n for each access point 114 associated with the respective VoIP communication (FIG. 6). That is, the performance evaluator 180 may average each segment mean opinion score 172 associated with a respective access point 114 during a single VoIP communication 14 to determine the communication mean opinion score 14Q or quality performance for that particular access point 114 for that particular VoIP communication 14. In some examples, the performance evaluator 180 determines a weighted average for the independent historical quality performance 10Q, 14Q, 114Q. That is, the performance evaluator 180 may determine a weighted average of the segment mean opinion scores 172 associated with each user device 10 and/or access point 114. For example, segment mean opinion scores 172 that are more recent are weighted more than segment mean opinion scores 172 that are less recent. In this way, the quality performance 10Q, 14Q, 114Q may more accurately reflect current conditions for the user device 10 or access point 114. In another example, the weights are based on a call duration of the corresponding VoIP communication 14 associated with each segment mean opinion score 172. For example, a longer call may be weighted greater than a shorter call.

Thus, the performance evaluator 180, in some implementations, determines quality scores for individual VoIP communications (i.e., the communication mean opinion scores 14Q) and determines a weighted average of each individual segment mean opinion score 172 for wireless access points 114 (and/or cellular network towers 115) at any given time period. Because the performance evaluator 180 determines quality performances 10Q, 114Q for both user devices 10 and access points 114 individually, network and device issues may be more readily identified.

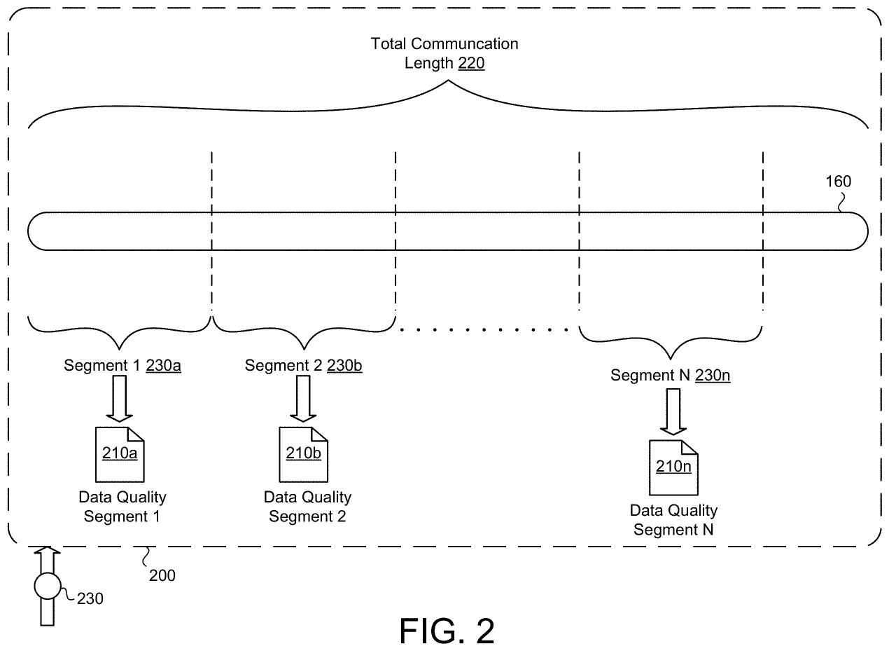

Referring now to FIG. 2, the data segmenter 200 segments the VoIP communication quality data 160 into data quality segments 210. The VoIP communication quality data 160 has a total length 220 (i.e., an amount of time) and the data segmenter 200 splits or segments the VoIP communication quality data 160 into data quality segments 210 with a length corresponding to a segment length 230. In some implementations, the segment length 230 is five seconds. In this scenario, the data segmenter 200 segments the VoIP communication quality data 160 such that each data quality segment 210 represents quality data for five seconds of the VoIP communication 14. Typically, the VoIP communication 14 will not have a length that is an even multiple of the segment length 230. In this instance, the data segmenter 200 may discard the leftover portion of the VoIP communication quality data 160, or, alternatively, generate a data quality segment 210 that is less than the segment length 230 to accommodate the remainder of the VoIP communication quality data 160. The segment length 230 may be configurable, e.g., by an administrator of the VoIP quality determiner 150. For example, the segment length 230 may be configured to one second to increase accuracy. Alternatively, the segment length 230 may be configured to ten seconds when less accuracy is acceptable.

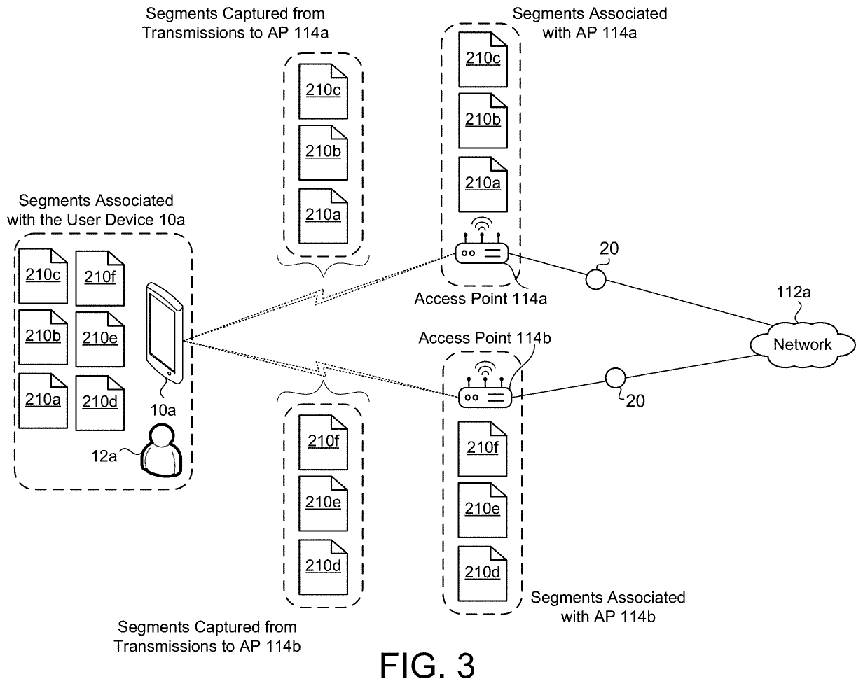

Referring now to FIG. 3, the user device 10a, during the VoIP communication 14, may connect to multiple different access points 114. That is, at least one of the VoIP communications 14 may be associated with a respective user device 10 communicating via at least two respective access points 114. For example, the user device 10a begins the VoIP communication 14 connected to the network 112a via the access point 114a, but during the communication 14, travel to a location where the user device 10a switches to access point 114b (e.g., due to user device's connection to the AP 114b exceeding the strength of the user device's connection to the AP 114a). In the example shown, the VoIP communication 14 generated six data quality segments 210 from VoIP communication data packets 20. The first three data quality segments 210a, 210b, 210c represent VoIP communication quality data 160 from a period of time when the user device 10a was connected to the access point 114a. The second three data quality segments 210d, 210e, 210f represent VoIP communication quality data 160 from a period of time during the same VoIP communication 14 when the user device 10a was connected to the access point 114b. As illustrated in FIG. 3, the VoIP quality determine 150 associates all six data quality segments 210a, 210b, 210c, 210d, 210e, 210f with the first user device 10a, the first three data quality segments 210a, 210b, 210c with the access point 114a, and the second three data quality segments 210d, 210e, 210f with the access point 114b. This provides granular access to quality data that allows the VoIP quality determiner 150 to isolate network issues between user devices 10 and access points 114.

In some implementations, the VoIP quality determiner 150 also associates data quality segments 210 with a respective user 12. For example, a user 12 may log in or otherwise authenticate themselves with the user device 10 prior to communication to establish an identity for the communication. The VoIP quality determiner 150 may in turn associate the data quality segments 210 with the user 12 (along with the associated user device 10 and access point 114/cellular network tower 115) even as the user switches between different user devices 10.

Based on the associations with the user devices 10, users 12, and access points 114 (and/or cellular network towers 115) and respective data quality segments 210, the corresponding segment mean opinion scores 172 are also associated with the user devices 10, users 12, and access points 114. The VoIP quality determiner may statistically analyze the segment mean opinion scores 172 associated with each user device 10, user 12, and access point 114 to determine the overall historical quality performance 10Q, 12Q, 14Q, 114Q for each user device 10, user 12, and access point 114. For example, the segment mean opinion scores 172 may be averaged (e.g., using a weighted average) to obtain the corresponding historical quality performance 10Q, 12Q, 14Q, 114Q. In some implementations, the VoIP quality determiner 150 stores and maintains the historical quality performance 10Q, 12Q, 14Q, 114Q and generates alerts (e.g., an email) to a user 12 or respective owner of a user device 10 when the corresponding historical quality performance 10Q, 12Q, 14Q, 114Q satisfies a threshold score. For example, when the historical quality performance 10Q, 12Q, 14Q, 114Q falls below the threshold for a respective user 12, the VoIP quality determiner 150 may generate and transmit an alert to the user 12. Similar alerts may be generated for user devices 10, APs 114, and cellular network towers 115.

In some examples, the VoIP quality determiner 150 receives the VoIP communication quality data 160 in real-time or near real-time (i.e., as the communication 14 is still ongoing between the users 12a, 12b). The VoIP quality determiner 150 may determine segment mean opinion scores 172 in real-time from the VoIP communication quality data 160 and, when segment mean opinion scores 172 fall below a threshold value (or the average or the weighted average of some or all of the segment mean opinion scores 172 of the communication 14 fall below the threshold value) the VoIP quality determiner 150 may provide a warning or notification to the user 12 of the user device. The threshold value may be configurable (e.g., by the user or system administrator). Optionally, the VoIP quality determiner 150 may determine another suitable access point 114 or cellular network tower 115 within range of the user device 10 and recommend or prompt the user 12 (via, for example, an application executing on the user device 12, a text message, email, etc.) to switch to the other access point 114 or cellular network tower 115. In other examples, the VoIP quality determiner may automatically switch the user device to the other access point 114 or cellular tower 115 without the user's intervention. The VoIP quality determiner may log or otherwise record the switch between access points 114/cellular network towers and/or notify the user 12 when such a switch occurs (e.g., via an application or other messaging service).

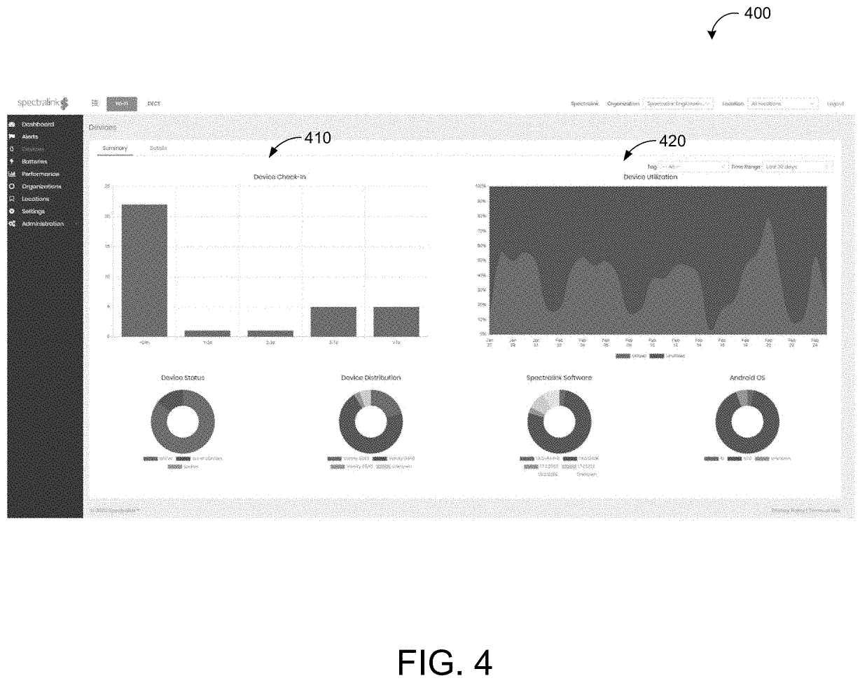

In some implementations, the VoIP quality determiner 150 includes an application that generates a graphical user interface (GUI). A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications. A user 12 or administrator of the system 100 may interact with the GUI 400 to obtain a wide variety of data, such as user device 10 and access point 114 status, connection history, and historical quality performance. Referring now to FIG. 4, an exemplary GUI 400 provides user device check-in information 410 and user device utilization information 420. The information may be categorized and displayed in a number of fashions. For example, various graphs and charts may represent user device status and user device distribution.

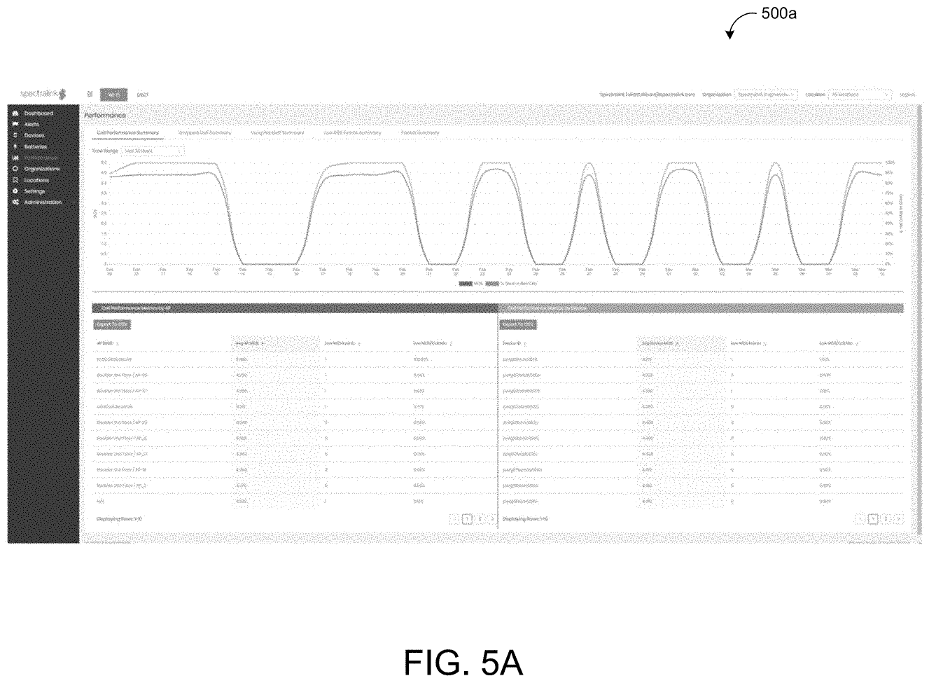

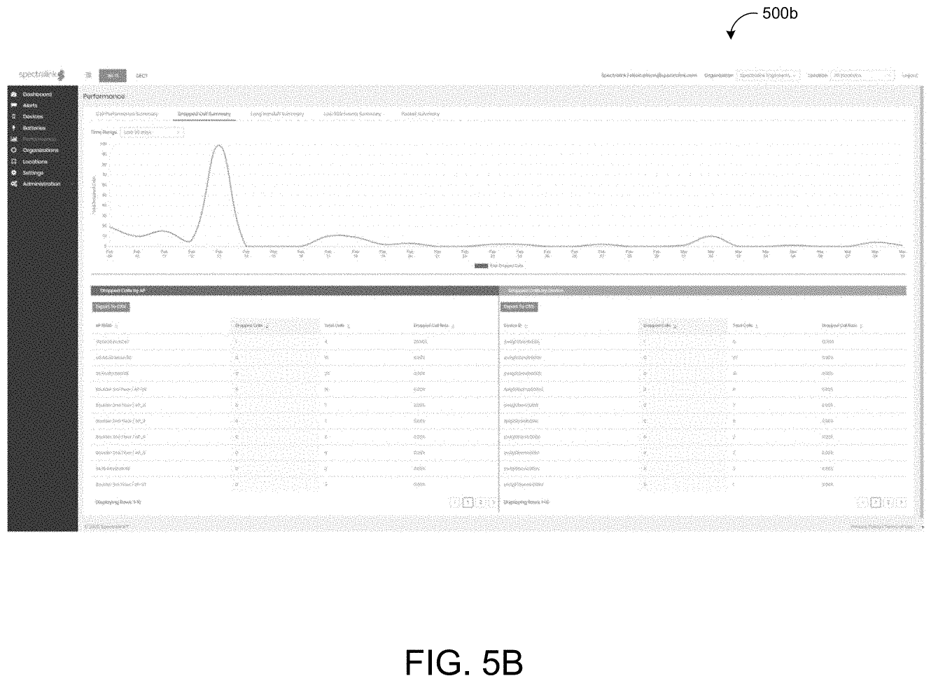

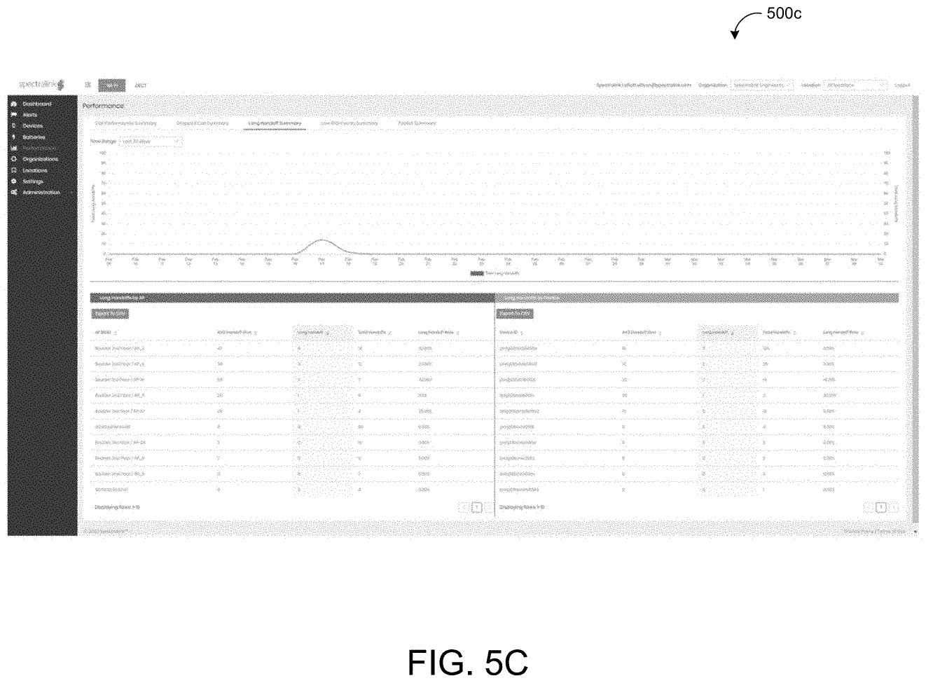

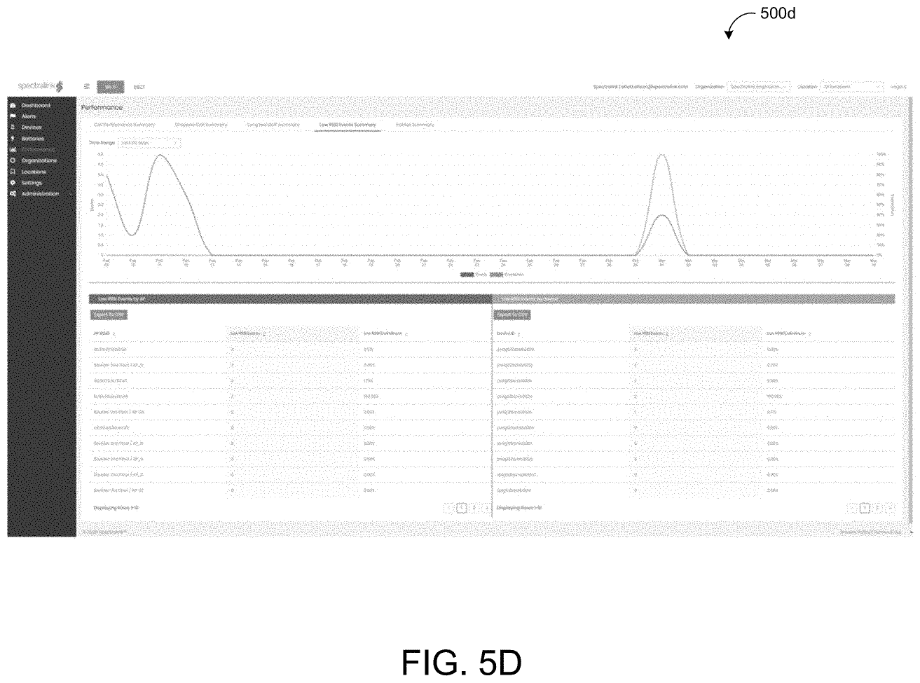

FIGS. 5A-5D illustrate additional exemplary GUIs 500a-d. Here, different performance parameters may be viewed. For example, a call performance summary (FIG. 5A), a dropped calls summary (FIG. 5B), a long handoff summary (FIG. 5C), a low received signal strength indication (RSSI) (FIG. 5D), and/or a packet summary may be viewed for each user device 10, user 12, access point 114, and cellular network tower 115 independently. Any of the information may be plotted on a timescale in order to easily correlate performance with periods of time.

Referring now to FIGS. 6A-6C, yet more exemplary GUIs 600a-c illustrate how the VoIP quality determiner 150 may determine and display quality and performance information for each access point 114 used during a VoIP communication. As illustrated in FIG. 6A, a VoIP communication was initiated while a user device 10 was connected to access point 114 “AP_8”. The VoIP communication 14 used this access point 114 for 22 seconds before switching to access point 114 “AP_6” and the communication completed 32 seconds later. In this example, the VoIP quality determiner 150 determines that the average of the segment mean opinion scores 172 while the user device 10 was connected to access point 114 “AP_8” was 4.409 and the average of the segment mean opinion scores 172 while the user device 10 was connected to access point 114 “AP_6” was 4.405. That is, the VoIP quality determiner 150 may determine an average AP quality score 610 for each AP 114 used during a communication. The historical quality performance 14Q for the communication, in this example, was 4.406. The VoIP quality determiner may determine historical quality performance 14Q for the communication based on the weighted average of each AP quality score 610. For example, the greater the percentage of a communication that a respective AP 114 is associated, the greater the weight for the respective AP quality score 610. When only a single AP 114 is used during a communication, the AP quality score 610 may be equivalent to the historical quality performance 14Q for the communication. Thus, an administrator or user of the system 100 may correlate issues to a specific user device 10 or access point 114.

In a similar example, FIG. 6B illustrates a communication 14 that started with a user device 10 connected to AP_6, then switched to AP_2, then switched to AP_13. After that, the user device switched back to AP_2 and then back again to AP_6. Each connection with an access point 114 is associated with a respective AP quality score 610 (i.e., the average of each segment mean opinion score 172 associated with the respective section of communication). Additionally, GUI 600b also displays the historical quality performance 14Q for the communication 14. The GUI 600a-b may include additional information, such as call start time, call end time, and the start and end times of connections to each specific access point 114.

In some examples, the GUI 600c (FIG. 6C) displays additional communication information 630 (e.g., call start time, inbound/outbound information, SIP extension, call dropped information, etc.). Additionally or alternatively, the GUI 600c may display plots of various information. For example, plot 640 plots each segment mean opinion score 172 with respect to time. The plot 640 may be delineated 620a-620e based on connections to specific access points 114. That is, the plot 640 may indicate when a connection a different access point 114 (or cellular network tower 115) occurs during the communication 14. In some implementations, a plot 650 plots jitter (obtained from the VoIP communication quality data 160) while a plot 660 plots packet loss (also obtained from the VoIP communication quality data 160).

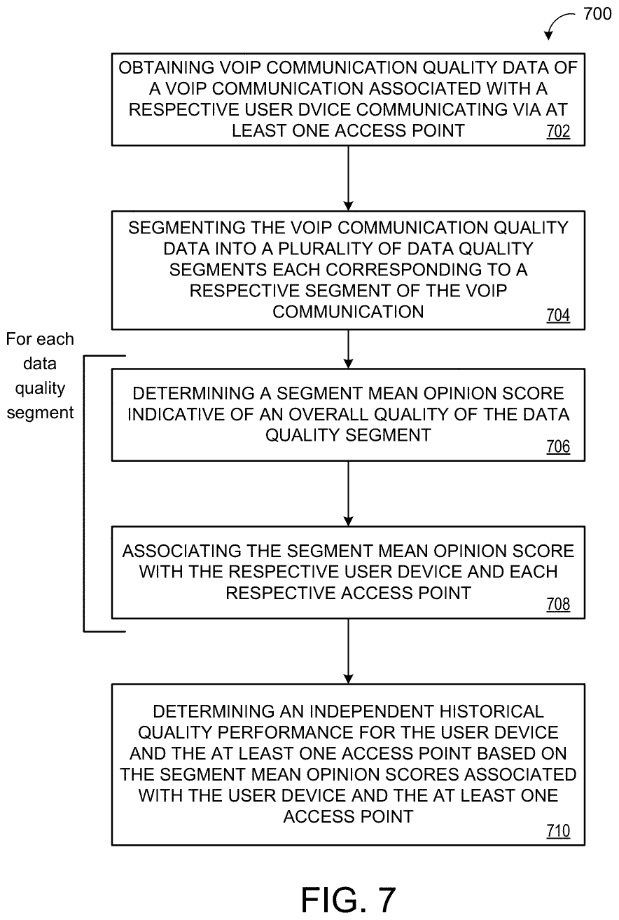

FIG. 7 is a flowchart of an exemplary arrangement of operations for a method 700 of determining a quality of a VoIP communication 14. The method 700 includes, at step 702, obtaining, at data processing hardware 18, 144, VoIP communication quality data 160 for at least one VoIP communication 14. Each VoIP communication 14 is associated with a respective user device 10 of a plurality of user devices 10 communicating via at least one respective access point 114 of a plurality of access points 114, and each VoIP communication 14 is associated with respective VoIP communication quality data 160.

For each VoIP communication 14, the method 700 includes, at step 704, segmenting, by the data processing hardware 18, 144, the VoIP communication quality data 160 into a plurality of data quality segments 210. Each data quality segment 210 corresponds to a respective segment of the VoIP communication 14. For each data quality segment 210, the method 700 includes, at step 706, determining, by the data processing hardware 18, 144, a segment mean opinion score 172 for the data quality segment 210 indicative of an evaluation of an overall quality of the data quality segment 210. At step 708, the method includes associating, by the data processing hardware 18, 144, the segment mean opinion score 172 with the respective user device 10 and each respective access point 114. The method 700, at step 710, includes determining, by the data processing hardware 18, 144, an independent historical quality performance 10Q, 114Q for the user device 10 of the plurality of user devices 10 and for the at least one access point 114 of the plurality of access points 114 based on the segment mean opinion scores 172 associated with the user device 10 and the at least one access point 114.

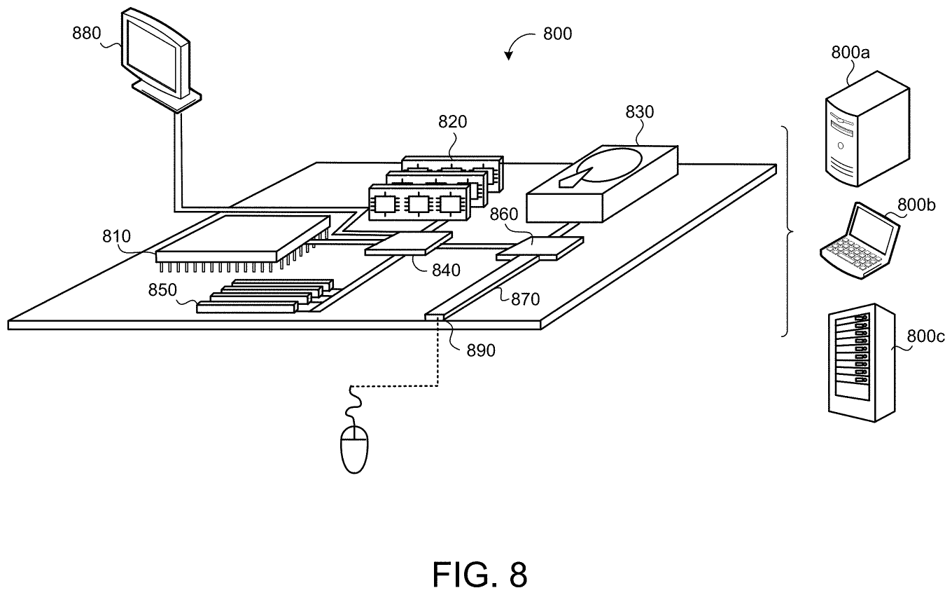

FIG. 8 is schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer implemented method that, when executed by data processing hardware, causes the data processing hardware to perform operations comprising:
obtaining voice over Internet Protocol (VoIP) communication quality data for at least one VoIP communication, each VoIP communication associated with a respective user device of a plurality of user devices communicating via at least one respective access point of a plurality of access points, and each VoIP communication associated with respective VoIP communication quality data;
for each VoIP communication, segmenting the VoIP communication quality data into a plurality of data quality segments, each data quality segment corresponding to a respective segment of the VoIP communication;
for each data quality segment:
determining a segment mean opinion score for the data quality segment indicative of an evaluation of an overall quality of the data quality segment; and
associating the segment mean opinion score with the respective user device and each respective access point; and
determining an independent historical quality performance for the user device of the plurality of user devices and for the at least one access point of the plurality of access points based on the segment mean opinion scores associated with the user device and the at least one access point.

2. The method of claim 1, wherein the operations further comprise determining an independent historical quality performance for each user device of the plurality of user device and for each access point of the plurality of access points based on the segment mean opinion scores associated with each respective user device and each access point.

3. The method of claim 1, wherein the VoIP communication quality data comprises at least one of jitter, latency, or packet loss.

4. The method of claim 1, wherein the VoIP communication quality data comprises voice over Wi-Fi communication quality data.

5. The method of claim 1, wherein at least one of the VoIP communications is associated with a respective user device of the plurality of user devices communicating via at least two respective access points of the plurality of access points.

6. The method of claim 1, wherein obtaining the VoIP communication quality data comprises obtaining the VoIP communication quality data in real-time, and wherein the operations further comprise:
determining a communication quality score for the VoIP communication associated with the real-time VoIP communication quality data based on the segment mean opinion scores;
when the communication quality score satisfies a threshold, determining a different access point within range of the user device; and
switching the VoIP communication to the different access point.

7. The method of claim 1, wherein the operations further comprise, for each VoIP communication, determining a communication mean opinion score for each access point associated with the respective VoIP communication.

8. The method of claim 1, wherein determining the independent historical quality performance of the at least one access point of the plurality of access points comprises determining a weighted average of the segment mean opinion scores associated with the at least one access point.

9. The method of claim 1, wherein determining the independent historical quality performance of the user device of the plurality of user devices comprises determining a weighted average of the segment mean opinion scores associated with the user device.

10. The method of claim 9, wherein the weighted average of the segment mean opinion scores associated with each user device is weighted based on a call duration of the corresponding VoIP communication associated with each segment mean opinion score.

11. A system comprising:
data processing hardware; and
memory hardware in communication with the data processing hardware, the memory hardware storing instructions that when executed on the data processing hardware cause the data processing hardware to perform operations comprising:
receiving voice over Internet Protocol (VoIP) communication quality data for a plurality of VoIP communications, each VoIP communication associated with a respective user device of a plurality of user devices communicating via at least one respective access point of a plurality of access points, and each VoIP communication associated with respective VoIP communication quality data;
for each VoIP communication, splitting the VoIP communication quality data into a plurality of data quality segments, each data quality segment corresponding to a respective segment of the VoIP communication;
for each data quality segment:
determining a segment mean opinion score for the data quality segment indicative of an evaluation of an overall quality of the data quality segment; and
associating the segment mean opinion score with the respective user device and each respective access point; and
determining an independent historical quality performance for the user device of the plurality of user devices and for the at least one access point of the plurality of access points based on the segment mean opinion scores associated with the respective user device and the at least one access point.

12. The system of claim 11, wherein the operations further comprise determining an independent historical quality performance for each user device of the plurality of user device and for each access point of the plurality of access points based on the segment mean opinion scores associated with each respective user device and each access point.

13. The system of claim 11, wherein the VoIP communication quality data comprises at least one of jitter, latency, or packet loss.

14. The system of claim 11, wherein the VoIP communication quality data comprises voice over Wi-Fi communication quality data.

15. The system of claim 11, wherein at least one of the VoIP communications is associated with a respective user device of the plurality of user devices communicating via at least two respective access points of the plurality of access points.

16. The system of claim 11, wherein obtaining the VoIP communication quality data comprises obtaining the VoIP communication quality data in real-time, and wherein the operations further comprise:
determining a communication quality score for the VoIP communication associated with the real-time VoIP communication quality data based on the segment mean opinion scores;
when the communication quality score satisfies a threshold, determining a different access point within range of the user device; and
switching the VoIP communication to the different access point.

17. The system of claim 11, wherein the operations further comprise, for each VoIP communication, determining a communication mean opinion score for each access point associated with the respective VoIP communication.

18. The system of claim 11, wherein determining the independent historical quality performance of the at least one access point of the plurality of access points comprises determining a weighted average of the segment mean opinion scores associated with the at least one access point.

19. The system of claim 11, wherein determining the independent historical quality performance of the user device of the plurality of user devices comprises determining a weighted average of the segment mean opinion scores associated with the user device.

20. The system of claim 19, wherein the weighted average of the segment mean opinion scores associated with each user device is weighted based on a call duration of the corresponding VoIP communication associated with each segment mean opinion score.
